(19) United States
(12) Patent Application Publication
(10) Pub. No.: US 2007/0149330 A1
(43) Pub. Date: Jun. 28, 2007

(54) Plate element for a chain

(75) Inventors: Marcus Junig, Buhlertal (DE); Anton Simonov, Buhl (DE); Martin Vornehm, Buhl (DE); Olga Ispolatova, Buhl (DE); Michael Pichura, Buhl (DE); Christoph Mayerhofer, Ottersweier (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/634,798

(22) Filed: Dec. 6, 2006

Related U.S. Application Data
(60) Provisional application No. 60/748,055, filed on Dec. 7, 2005.

(51) Int. Cl. F16H 7/06

(52) U.S. Cl. 474/157

(57) ABSTRACT

A plate element for a plate-link chain includes a functional feature that is asymmetrical relative to an axis of the plate element. The plate element has a non-functional region at which an orientation feature is positioned asymmetrically relative to the axis of symmetry of the plate element that is perpendicular to the chain movement direction and is parallel to the front and back faces of the plate element.

### BACKGROUND OF THE INVENTION

1. Field of the Invention

The present invention relates to a plate element for a plate-link chain, in particular a toothed plate for a toothed chain.

2. Description of the Related Art

Chains of the type that are installed as power transmission elements in transmissions are assembled using plate elements and rocker members, with the plate elements having one or more openings in which the rocker members are received. Two plate elements are connected by the engagement of a rocker member with both of the plate elements.

When toothed chains are constructed from a single type of toothed plate that is symmetrical relative to an axis that is perpendicular to the direction of an extended chain, when the chain is straight the chain produces undesired noises during operation, and it is thus inadequate in terms of its acoustic behavior.

It is known to use so-called randomized toothed chains made of at least two different types of toothed plates. The two plate types differ in a functional feature, for example the shapes of the teeth. The orientation of installation of the plates is immaterial in that case, and the randomization is achieved by random selection of the plate elements and hence of their order in the chain. Instead of using two or more different toothed plates, it is also known to make randomized toothed chains from one type of asymmetrical toothed plate, in which case the randomization is achieved by the toothed plates being installed in a particular orientation. The asymmetry of the plate arises, for example, from a functional feature that is asymmetrically formed, such as a difference in the shapes of the two plate teeth. The plate is assembled into a chain in a certain pattern or at random, sometimes with a first surface facing the observer and sometimes with a second, opposite surface facing the observer. The advantage over the use of two different types of toothed plates is that only one type of plate has to be kept in inventory, which is advantageous with regard to the production of the plates, since, for example, different stamping dies are not needed. Of course, when one type of toothed plate is used greater effort is needed in assembly and quality assurance in order to ensure that the chain has been assembled randomly.

An object of the invention is to provide a plate element for a plate-link chain, in particular a toothed plate for a toothed chain, with asymmetrical functionalities and that can easily be assembled into a chain.

### SUMMARY OF THE INVENTION

The object is achieved by providing plate element for a chain with a configuration that is asymmetrical relative to an axis of symmetry of the plate element, wherein the plate element has a region on which an orientation feature is placed asymmetrically relative to the axis of symmetry of the plate element.

The term functionality as used herein relates to a geometric feature of the plate element that ensures that randomized interaction of individual plate elements of the chain with opposing elements of a drive arrangement occurs during operation. An example of such a functionality is the tooth shape of the plate elements, in the case of toothed plates for toothed chains.

The axis of symmetry of the plate element is generally an axis of symmetry of a plate element installed in a chain and that is perpendicular to a chain extension direction when the chain is stretched out straight.

The invention is based on the concept of using only a single plate element that has asymmetrical functionality, so that it results in a randomized chain when installed in a chain in one direction or another. To simplify the installation direction or the sorting of the identical plate elements in accordance with their orientation, in accordance with the invention an orientation feature, which is also asymmetrical with regard to the axis of symmetry of the plate element, is formed on the plate element. Based on that orientation feature, it is easy to recognize, either visually or through automated sorting, for example, in what orientation the plate element is supplied or is assembled into a chain. It is especially preferred for the invention to be used for plate elements that are toothed plates for a toothed chain. If the plate element contains two teeth, for example, one tooth profile of the toothed plate can differ from the other in its configuration and thus provide an asymmetrical functionality. In that manner, the orientation feature helps to recognize the orientation in which the toothed plate element is intended.

In accordance with an especially preferred exemplary embodiment, the orientation feature is placed in a non-functional region of the outer contour of the plate element, or, alternatively, of the body of the plate element. For example, a toothed plate element includes a functional region on which the teeth are provided, and a non-functional region that connects the two sides of the functional regions. The orientation feature can preferably be placed along that outer contour, in which no functionality is provided, or in the inner region of the toothed plate element, without impairing the overall functionality of the plate element.

For example, the orientation feature can be an asymmetrical increase in the mass of the plate element. That offers the advantage that the plate elements can be sorted using the displacement of the center of gravity. The change in mass of one half of the tooth element compared to the other can be produced for example by hollowing out a non-functional region of the body. Other possibilities for the orientation feature are the provision of a change in the reflective behavior of an incident light beam depending on the orientation in which the plate element is transported, or asymmetrical placement of clearly visually recognizable contour forms or mechanical gripping regions.

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a toothed chain having plate elements shown in a random installation;

FIG. 2 is a side view of a known asymmetrical plate element;

FIG. 3 is a side view of an asymmetrical plate element including an orientation feature;

FIG. 4 is a side view of another embodiment of an asymmetrical plate element including an orientation feature;

FIG. 5 is a side view of a further embodiment of an asymmetrical plate element including an orientation feature that facilitates the reading of the orientation feature by optical means; and

FIG. 6 is a side view of the plate element of FIG. 5 when the orientation feature is read mechanically.

### DESCRIPTION OF THE PREFERRED EMBODIMENTS

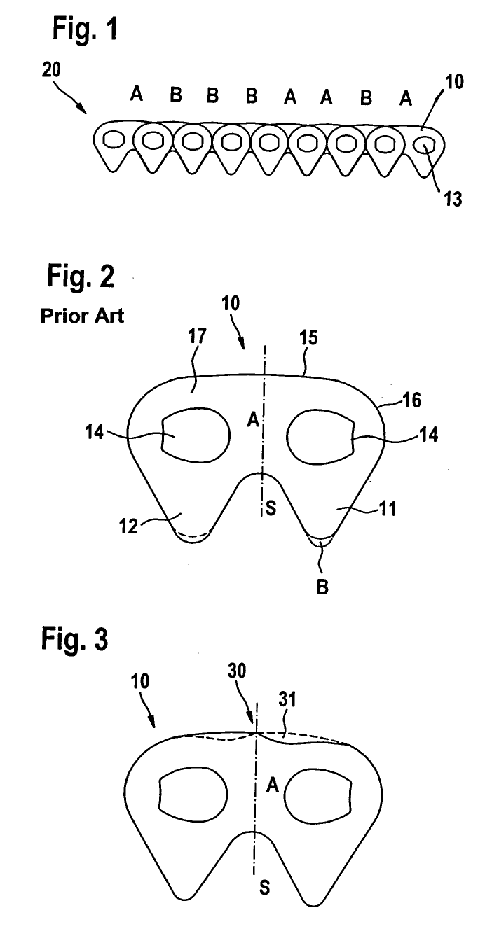

FIG. 1 is a side view of a toothed chain 20 that is made up of identical asymmetrical plate elements 10 that are in the form of toothed plates 10, each plate element having two teeth 11, 12. A single such toothed plate element is shown in FIG. 2. It can be seen that the teeth 11 and 12 have a slightly different shape. In FIG. 2, dashed lines show the case in which plate element 10, instead of being positioned with side A facing the observer, as shown in solid lines in FIG. 2, is positioned with the opposite side B facing the observer, i.e., the plate element is turned over.

FIG. 1 illustrates by means of letters A and B how the tooth elements 10 are assembled in random order, i.e., with sides A or B oriented in a particular direction, with the order alternating at random, i.e., irregularly, as shown in FIG. 1. The result of that orientation of plate elements 10 is that different or the same tooth geometries of the teeth 11, 12 end up lying against each other with the plate elements 10 overlapping when assembled into a chain, and thereby provide quieter chains 20.

In addition, the individual plate elements 10 have through-openings 14 into which rocker elements 13 can be inserted, which together with the contour of the through opening 14 form rocker joints.

The plate elements generally have functional regions, namely, for example, the cutouts or through-openings 14 and the tooth geometries of the teeth 11, 12, as well as non-functional regions, namely, for example, the contoured edge 15 lying opposite to the teeth, or the transition regions 16 between the contoured edge 15 and the teeth, in the form of rounded curves. Other non-functional regions of the plate element are also regions of the body, such as the interior of the plate element, i.e., the side surfaces A or B.

In accordance with the invention, an orientation feature 30 in accordance with FIG. 2 is added to an otherwise non-functional region of an asymmetrical plate element 10.

Examples of such orientation features are illustrated in FIGS. 3 through 6.

The toothed plates 10 in accordance with FIGS. 3 through 6 can be assembled into a chain 20 in the same way as the toothed plate 10 of FIG. 2.

In FIG. 3 the orientation feature 30 of plate element 10 is a contour change of the non-functional peripheral edge of plate element 10, in particular of the contoured edge 15 that lies opposite the teeth 11, 12. The dashed lines in FIG. 3 show how the plate element 10 looks in the turned orientation. The asymmetry of the tooth geometry of teeth 11, 12 relative to the axis S as shown in FIG. 2 is not repeated in FIGS. 3, 4, and 6, but is similar to that in FIG. 2, for example. Alternatively, a different function-influencing asymmetrical feature relative to the axis S can be provided.

Orientation feature 30 is also asymmetrical relative to the same axis S. The contour change 31 of contoured edge 15 of the plate element is composed of a convexity on one side of the axis S and a depression or concavity on the other side of the axis S. The other features of plate element 10 are the same as those shown in FIG. 2.

As used herein, the contour of the plate element refers to the shape of the plate element when viewed from the side relative to the direction of motion of a chain 20 having assembled plate elements 10.

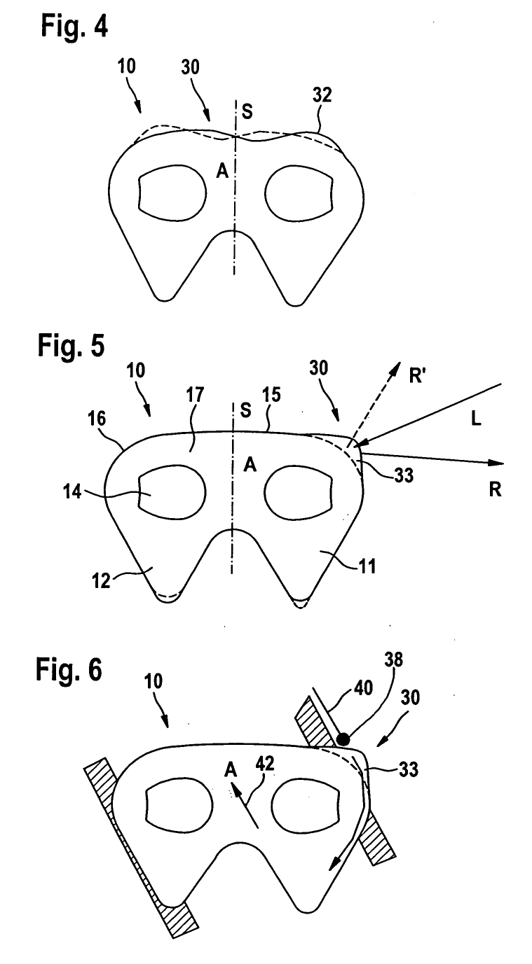

FIG. 4 shows an alternative contour change on the upwardly-facing edge of the plate, or on contoured edge 15, composed of a sinusoidal curve or wave form 32. Also in FIG. 4, features identical to those in FIG. 2 are omitted and are not described again.

Because of the contour change on the upwardly-facing edge of the plate, the orientations of the individual plate elements 10 can be recognized easily through visual observation, for example, even when the chain 20 is in the assembled state.

Another alternative is to thicken the mass of the plate element asymmetrically with regard to the axis S in the non-functional surface region 17 (see FIG. 2) of plate element 10.

Another alternative for an orientation feature 30 is shown in FIG. 5, in which a first transition region 16 between the teeth 11, 12 and the plate upper edge, i.e., the non-functional contoured edge 15, has a gently rounded shape, while a second transition region 33 is configured as an angular corner having a vertex, i.e., it deviates in shape from the uniformly curved first transition region 16. The other features are again identical to those shown in FIG. 2.

FIG. 5 additionally shows how the orientation feature 30, i.e., the deviation between the two transition regions, represented by region 33, can be detected and associated with an orientation of the plate element 10. That detection can be done by optical means, for example, by causing an incident light beam L to reflect from the transition region contour, in particular the transition region 16 or 33. The direction of reflection of light beam L for the orientation in the illustration, having the solid lines shown in FIG. 5, i.e., with surface A facing the observer, is designated by arrow R, also having a solid line, while the reflection with plate element 10 oriented in the opposite position i.e., with surface B facing the observer in FIG. 5, is indicated by dashed arrow R′. The reflected light beam can be conveyed to an analysis unit, which associates the detected reflection with an orientation of the plate element 10. The detected reflection is a function of the direction of the reflected beam, and, for example, activates a mechanical switch on a conveyor belt (not shown) carrying the plate elements 10, in order to sort the plates by their orientation. Alternatively, the plate itself can also be detected by recording the top view, and when there are different contours in accordance with FIGS. 3 through 5, for example, their orientation can be recognized by means of an image recognition system.

Another way to detect the orientation feature is shown in FIG. 6, wherein a mechanical deflector 38 of a sorting unit 40 causes a plate element 10 moving in the direction of arrow 42, whose orientation is shown in FIG. 6 with solid lines and with surface A facing the observer, to come into contact with the deflector of the sorting unit 40 and to be turned clockwise as shown, so that it can be sent to a sorting device, while a plate element 10 with the opposite orientation (surface B facing the observer) passes the sorting unit 40 without being turned.

The essential aspect of the invention thus involves placing in a non-functional region of a plate element an orientation feature that is easier to read or to detect visually than the asymmetry feature, such as the asymmetrical teeth, that is required for the asymmetrical functionality.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate element for a plate-link chain, said plate element comprising: a plate having a configuration that is asymmetrical relative to a symmetry axis of the plate element that is perpendicular to a chain movement direction and is parallel to front and back faces of the plate element, wherein the plate element includes a non-functional region at which a plate element orientation feature is positioned asymmetrically relative to the symmetry axis of the plate element for detecting orientation of a plate element.

2. A plate element in accordance with claim 1, wherein the plate element is a toothed plate for a toothed plate-link chain.

3. A plate element in accordance with claim 1, wherein the orientation feature is positioned at a non-functional region at an outer edge of the plate element.

4. A plate element in accordance with claim 1, wherein the orientation feature includes a mass enlargement of the plate element on one side of the symmetry axis of the plate element with respect to another side of the symmetry axis.

5. A plate element in accordance with claim 1, wherein the orientation feature includes an asymmetrical contour at an edge of the plate element.

6. A plate element in accordance with claim 1, wherein the orientation feature is one of a bulge and an indentation at an edge of the plate element that is substantially straight.

7. A plate element in accordance with claim 1, wherein the orientation feature includes an asymmetrical configuration of two corner regions of the plate element in the form of a uniformly curved first corner region, and a second corner region that is curved differently from that of the first corner region.

8. A plate element in accordance with claim 1, wherein the orientation feature includes an asymmetrical opening in the plate element.

9. A plate-link chain, said chain comprising: a plurality if interconnected plate elements, and a plurality of rocker members that join respective ones of the plate elements and pass through and contact through-openings in the plate elements, wherein at least one plate element has a configuration that is asymmetrical relative to a symmetry axis of the plate element that is perpendicular to a chain movement direction and is parallel to front and back faces of the plate element, wherein the plate element includes a non-functional region at which a plate element orientation feature is positioned asymmetrically relative to the symmetry axis of the plate element for detecting orientation of a plate element.
